(19) United States
(12) Patent Application Publication
(10) Pub. No.: US 2024/0185087 A1
(43) Pub. Date: Jun. 6, 2024

(54) INTELLIGENT MODEL TRAINING METHOD AND APPARATUS

(71) Applicant: HUAWEI TECHNOLOGIES CO., LTD., Shenzhen (CN)

(72) Inventors: Mengyao MA, Shenzhen (CN); Kin Nang LAU, Hong Kong (CN); Liqun SU, Hong Kong (CN)

(73) Assignee: HUAWEI TECHNOLOGIES CO., LTD., Shenzhen, GD (CN)

(21) Appl. No.: 18/404,069

(22) Filed: Jan. 4, 2024

Related U.S. Application Data
(63) Continuation of application No. PCT/CN2022/100555, filed on Jun. 22, 2022.

(30) Foreign Application Priority Data
Jul. 7, 2021 (CN) 202110770808.8

(51) Int. Cl. G06N 3/098

(52) U.S. Cl. CPC G06N 3/098

(57) ABSTRACT

An intelligent model training method and apparatus. A plurality of participating nodes jointly train an intelligent model. This method is performed by one of the plurality of participating nodes, and the method includes: performing a K^{th} time of model training on the intelligent model to obtain first gradient information; and sending first synthetic gradient information to a central node, where the first synthetic gradient information includes synthetic information of the first gradient information and residual gradient information, and the residual gradient information represents a residual estimate of synthetic gradient information that is not transmitted to the central node before the K^{th} time of model training, where K is a positive integer.

### CROSS-REFERENCE TO RELATED APPLICATIONS

This application is a continuation of International Application No. PCT/CN2022/100555, filed on Jun. 22, 2022, which claims priority to Chinese Patent Application No. 202110770808.8, filed on Jul. 7, 2021. The disclosures of the aforementioned applications are hereby incorporated by reference in their entireties.

### TECHNICAL FIELD

The embodiments relate to the communication field, an intelligent model training method, and an apparatus.

### BACKGROUND

Artificial intelligence (AI) is very important disclosure in a future wireless communication network (for example, the Internet of Things). Different from disclosure of conventional centralized intelligent model training in which all datasets are aggregated to a server and the server performs model training, modern machine learning proposes a federated learning manner. Federated learning is a distributed intelligent model training method. The server provides model parameters for a plurality of devices. After performing intelligent model training based on respective datasets, the plurality of devices separately feed back gradient information of a loss function to the server, and the server obtains updated model parameters based on the gradient information from the plurality of devices. The federated learning can resolve problems of time consumption and large communication cost that is caused by data collection in centralized machine learning. In addition, because device data does not need to be sent to the server, privacy security problems can also be reduced.

However, the gradient information received by the server may be distorted due to impact of a transmission channel condition, so that efficiency of performing model training through federated learning is low currently.

### SUMMARY

The embodiments provide an intelligent model training method and apparatus, to improve intelligent model training efficiency.

According to a first aspect, an intelligent model training method is provided. A plurality of participating nodes jointly train an intelligent model. This method is performed by one of the plurality of participating nodes.

The method includes: performing a K^{th} time of model training on the intelligent model, to obtain first gradient information; and sending first synthetic gradient information to a central node, where the first synthetic gradient information includes synthetic information of the first gradient information and residual gradient information, and the residual gradient information represents a residual estimate of synthetic gradient information that is not transmitted to the central node before the K^{th} time of model training, where K is a positive integer.

According to the foregoing solution, after one time of model training, the participating node may send, to the participating node, gradient information obtained through training and residual gradient information that is estimated by the participating node and that is not transmitted to the central node before the current model training In this way, the central node can obtain residual gradient information (or referred to as compensated gradient information), so that a convergence speed of a loss function can be improved, and the model training efficiency can be improved.

With reference to the first aspect, in some implementations of the first aspect, the residual gradient information includes a residual estimate of second synthetic gradient information weighted by a weighting coefficient, and the second synthetic gradient information is synthetic gradient information that is last sent to the central node before the K^{th} time of model training.

With reference to the first aspect, in some implementations of the first aspect, the method further includes: determining the residual estimate of the second synthetic gradient information based on the second synthetic gradient information, a transmission power corresponding to the second synthetic gradient information, and channel information corresponding to the second synthetic gradient information.

According to the foregoing solution, a loss of the second synthetic gradient information in a transmission process is estimated as the residual estimate based on the transmission power and the channel information that correspond to the second synthetic gradient information. The residual estimate is transferred to the central node by using the first synthetic gradient information, so that the central node can obtain the residual gradient information, the convergence speed of the loss function can be improved and the model training efficiency is improved.

With reference to the first aspect, in some implementations of the first aspect, the second synthetic gradient information may be synthetic gradient information that is sent to the central node after a Q^{th} time of model training. Q is a positive integer less than K. The weighting coefficient is related to a learning rate of the K^{th} time of model training and/or is related to a learning rate of the Q^{th} time of model training.

With reference to the first aspect, in some implementations of the first aspect, the second synthetic gradient information is the synthetic gradient information that is sent to the central node after the Q^{th} time of model training. The residual gradient information further includes synthetic information of N pieces of gradient information. The N pieces of gradient information are gradient information that is obtained through N times of model training after the Q^{th} time of model training and before the K^{th} time of model training and that is not sent to the central node before the K^{th} time of model training. K is greater than Q, N=K−Q−1, and Q is a positive integer.

According to the foregoing solution, the residual gradient information further includes the synthetic information of the N pieces of gradient information obtained through the N times of model training between the Q^{th} time of model training and the K^{th} time of model training. In this way, the central node can obtain not only the gradient information that is not fed back, but also a residual amount of synthetic gradient information at a previous time. This can improve the convergence speed of the loss function and improve the model training efficiency.

With reference to the first aspect, in some implementations of the first aspect, the sending first synthetic gradient information to a central node includes: determining that a transmission power corresponding to the first synthetic gradient information is greater than a power threshold; and sending the first synthetic gradient information to the central node.

With reference to the first aspect, in some implementations of the first aspect, the method further includes: if the transmission power corresponding to the first synthetic gradient information is less than or equal to the power threshold, skipping sending the first synthetic gradient information to the central node.

According to the foregoing solution, when communication cost is large and a channel condition is poor, the synthetic gradient information is not sent to the central node. This can reduce resource waste and improve resource utilization.

With reference to the first aspect, in some implementations of the first aspect, the method further includes: determining the transmission power of the first synthetic gradient information based on communication price metric information, channel information corresponding to the first synthetic gradient information, and the first synthetic gradient information, where the communication price metric information represents a cost volume of communication between one participating node and the central node.

With reference to the first aspect, in some implementations of the first aspect, the power threshold is in direct proportion to the communication price metric information and/or the power threshold is in direct proportion to an activation power of the participating node. The communication price metric information represents the cost volume of communication between the participating node and the central node.

With reference to the first aspect, in some implementations of the first aspect, the method further includes: receiving the communication price metric information from the central node.

According to the foregoing solution, the participating node may obtain the communication price metric information from the central node, so that the participating node may determine, based on a communication price metric, whether to send the synthetic gradient information to the central node.

With reference to the first aspect, in some implementations of the first aspect, the performing a K^{th} time of model training on the intelligent model includes: receiving model parameter information from the central node; and performing the K^{th} time of model training on the intelligent model, where the intelligent model is a model configured based on the model parameter information.

According to a second aspect, an intelligent model training apparatus is provided. The apparatus is a participating node or a module (for example, a chip) configured in (or used in) the participating node.

The communication apparatus includes: a processing unit, configured to perform a K^{th} time of model training on an intelligent model to obtain first gradient information; and a transceiver unit, configured to send first synthetic gradient information to a central node, where the first synthetic gradient information includes synthetic information of the first gradient information and residual gradient information, and the residual gradient information represents a residual estimate of synthetic gradient information that is not transmitted to the central node before the K^{th} time of model training, where K is a positive integer.

With reference to the second aspect, in some implementations of the second aspect, the residual gradient information includes a residual estimate of second synthetic gradient information weighted by a weighting coefficient, and the second synthetic gradient information is synthetic gradient information that is last sent to the central node before the K^{th} time of model training.

With reference to the second aspect, in some implementations of the second aspect, the processing unit is further configured to determine the residual estimate of the second synthetic gradient information based on the second synthetic gradient information, a transmission power corresponding to the second synthetic gradient information, and channel information corresponding to the second synthetic gradient information.

With reference to the second aspect, in some implementations of the second aspect, the second synthetic gradient information may be synthetic gradient information that is sent to the central node after a Q^{th} time of model training. Q is a positive integer less than K. The weighting coefficient is related to a learning rate of the K^{th} time of model training and/or is related to a learning rate of the Q^{th} time of model training

With reference to the second aspect, in some implementations of the second aspect, the second synthetic gradient information is the synthetic gradient information that is sent to the central node after the Q^{th} time of model training. The residual gradient information further includes synthetic information of N pieces of gradient information. The N pieces of gradient information are gradient information that is obtained through N times of model training after the Q^{th} time of model training and before the K^{th} time of model training and that is not sent to the central node before the K^{th} time of model training. K is greater than Q, N=K−Q−1, and Q is a positive integer.

With reference to the second aspect, in some implementations of the second aspect, the processing unit is further configured to determine that a transmission power corresponding to the first synthetic gradient information is greater than a power threshold. The transceiver unit is further configured to send the first synthetic gradient information to the central node when the transmission power corresponding to the first synthetic gradient information is greater than the power threshold.

With reference to the second aspect, in some implementations of the second aspect, the transceiver unit is further configured to skip sending the first synthetic gradient information to the central node when the transmission power corresponding to the first synthetic gradient information is less than or equal to the power threshold.

With reference to the second aspect, in some implementations of the second aspect, the processing unit is further configured to determine the transmission power of the first synthetic gradient information based on communication price metric information, channel information corresponding to the first synthetic gradient information, and the first synthetic gradient information. The communication price metric information represents a cost volume of communication between one participating node and the central node.

With reference to the second aspect, in some implementations of the second aspect, the power threshold is in direct proportion to communication price metric information and/or the power threshold is in direct proportion to activation power of the participating node. The communication price metric information represents a cost volume of communication between the one participating node and the central node.

With reference to the second aspect, in some implementations of the second aspect, the transceiver unit is further configured to receive the communication price metric information from the central node.

With reference to the second aspect, in some implementations of the second aspect, the transceiver unit is configured to receive model parameter information from the central node. The processing unit may be configured to perform the K^{th} time of model training on the intelligent model, where the intelligent model is a model configured based on the model parameter information.

According to a third aspect, an intelligent model training apparatus is provided. The intelligent model training apparatus includes a processor. The processor may implement the method according to any one of the first aspect and the possible implementations of the first aspect. Optionally, the communication apparatus further includes a memory. The processor is coupled to the memory and may be configured to execute instructions in the memory, to implement the method according to any one of the first aspect or the possible implementations of the first aspect. Optionally, the communication apparatus further includes a communication interface, and the processor is coupled to the communication interface. In the embodiments, the communication interface may be a transceiver, a pin, a circuit, a bus, a module, or a communication interface of another type. This is not limited.

In an implementation, the intelligent model training apparatus is a participating node. When the intelligent model training apparatus is a participating node, the communication interface may be a transceiver or an input/output interface.

In another implementation, the intelligent model training apparatus is a participating node or a chip configured in the participating node. When the intelligent model training apparatus is the participating node or the chip configured in the participating node, the communication interface may be an input/output interface, and the processor may be a logic circuit.

The input/output interface is configured to send first synthetic gradient information to a central node. The first synthetic gradient information includes synthetic information of first gradient information and residual gradient information. The residual gradient information represents a residual estimate of synthetic gradient information that is not transmitted to the central node before a K^{th} time of model training K is a positive integer. The logic circuit is configured to perform the K^{th} time of model training on an intelligent model, to obtain the first gradient information. Optionally, the communication apparatus further includes a communication interface, and the processor is coupled to the communication interface.

Optionally, the transceiver may be a transceiver circuit. Optionally, the input/output interface may be an input/output circuit.

According to a fourth aspect, a processor is provided. The processor includes an input circuit, an output circuit, and a processing circuit. The processing circuit is configured to receive a signal by using the input circuit, and transmit a signal by using the output circuit, to enable the processor to perform the method according to any one of the first aspect and the possible implementations of the first aspect.

In an implementation process, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, for example but not limited to, a receiver, a signal output by the output circuit may be output to, for example but not limited to, a transmitter and transmitted by the transmitter, and the input circuit and the output circuit may be a same circuit. The circuit is used as the input circuit and the output circuit at different moments. Implementations of the processor and the various circuits are not limited in the embodiments .

According to a fifth aspect, a computer program product is provided. The computer program product includes a computer program (which may also be referred to as code or instructions). When the computer program is run, a computer is enabled to perform the method according to any one of the first aspect and the possible implementations of the first aspect.

According to a sixth aspect, a non-transitory computer-readable storage medium is provided. The non-transitory computer-readable storage medium stores a computer program (which may also be referred to as code or instructions). When the computer program is run on a computer, the computer is enabled to perform the method according to any one of the first aspect and the possible implementations of the first aspect.

According to a seventh aspect, a communication system is provided. The communication system includes the plurality of foregoing participating nodes and at least one central node.

For effects that can be achieved in any one of the second aspect to the seventh aspect and any possible implementation of the second aspect to the seventh aspect, refer to descriptions of effects that can be achieved in the first aspect and corresponding implementations of the first aspect. Details are not described herein again.

### BRIEF DESCRIPTION OF DRAWINGS

FIG. 1 is a schematic diagram of a communication system applicable to an embodiment;

FIG. 2 is a schematic flowchart of an intelligent model training method according to an embodiment;

FIG. 3 is another schematic flowchart of an intelligent model training method according to an embodiment;

FIG. 4 is a schematic diagram of sharing a transmission resource by a plurality of participating nodes according to an embodiment;

FIG. 5 is a schematic block diagram of an example of a communication apparatus according to an embodiment; and

FIG. 6 is a schematic diagram of a structure of an example of a communication device according to an embodiment.

### DETAILED DESCRIPTION OF EMBODIMENTS

In the embodiments, “/” may indicate an “or” relationship between associated objects. For example, A/B may indicate A or B. “And/or” may be used to describe three relationships between associated objects. For example, A and/or B may indicate the following three cases: only A exists, both A and B exist, and only B exists, where A and B may be singular or plural. To facilitate description of the embodiments, terms such as “first” and “second” in the embodiments may be used to distinguish between features having same or similar functions. The terms such as “first” and “second” do not limit a quantity and an execution sequence, and the terms such as “first” and “second” do not indicate a definite difference. In the embodiments, a term such as “example” or “for example” indicates an example, an illustration, or a description. Any embodiment described as an “example” or “for example” should not be explained as being more preferred or having more advantages than another embodiment. Use of the term such as “example” or “for example” is intended to present a relative concept in a manner for ease of understanding.

In the embodiments, “at least one (type)” may alternatively be described as “one (type) or more (types)”, and “a plurality of (types)” may be two (types), three (types), four (types), or more (types). This is not limited in the embodiments.

The following describes solutions with reference to accompanying drawings.

The embodiments may be applied to various communication systems, for example, a long term evolution (LTE) system, an LTE frequency division duplex (FDD) system, an LTE time division duplex (TDD) system, a 5^{th} generation (5G) communication system, a future communication system (for example, a 6^{th} generation (6G) communication system), or a system integrating a plurality of communication systems. This is not limited in the embodiments. 5G may also be referred to as new radio (NR).

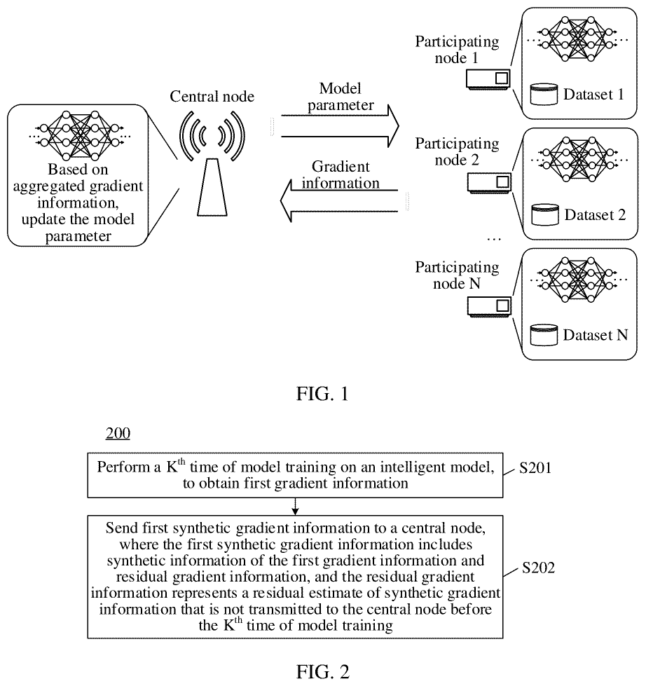

FIG. 1 is a schematic diagram of a communication system applicable to the embodiments.

As shown in FIG. 1, the communication system applicable to the embodiments may include at least one central node and at least one participating node, for example, participating nodes 1, 2, . . . , and N shown in FIG. 1. The central node may provide a model parameter for each participating node. After updating a model based on the model parameter provided by the central node, each participating node separately trains an updated model by using a local dataset. For example, the participating node 1 trains the model by using a local dataset 1, the participating node 2 trains the model by using a local dataset 2, . . . , and the participating node N trains the model by using a local dataset N. After performing model training, each participating node sends, to the central node, gradient information of a loss function obtained through current training. The central node determines aggregated gradient information of gradient information from each participating node, determines an updated model parameter based on the aggregated gradient information, and notifies each participating node, so that each participating node performs next model training.

The central node provided in the embodiments may be a network device, for example, a server or a base station. The central node may be a device that is deployed in a radio access network and that can directly or indirectly communicate with the participating node.

The participating node provided in this embodiment may be a terminal or a terminal device, and the participating node may be a device that has a receiving and sending function. The participating node may be deployed on land, indoor or outdoor, may be handheld, and/or vehicle-mounted, or may be deployed on a water surface (for example, a ship). For example, the participating node may be a sensor. The participating node may alternatively be deployed in the air (for example, on an airplane, a balloon, or a satellite). The participating node may be user equipment (UE). The UE includes a handheld device, a vehicle-mounted device, a wearable device, or a computing device with a wireless communication function. For example, the UE may be a mobile phone, a tablet computer, or a computer having a wireless transceiver function. The terminal device may alternatively be a virtual reality (VR) terminal device, an augmented reality (AR) terminal device, a wireless terminal in industrial control, a wireless terminal in self-driving, a wireless terminal in telemedicine, a wireless terminal in a smart grid, a wireless terminal in a smart city, a wireless terminal in a smart home, and/or the like.

The solutions provided in the embodiments may be applied to a plurality of scenarios such as smart retail, smart home, video surveillance (video surveillance), Internet of Vehicles (for example, self-driving and unmanned driving), an industrial wireless sensor network (IWSN), and the like. However, is the embodiments are not limited thereto.

In an implementation, the solutions may be applied to the smart home, to provide a personalized service for a customer based on a customer requirement. The central node may be a base station or a server, and the participating node may be a client device disposed in each home. Based on the solutions, the client device provides only the server with synthetic gradient information obtained after model training is performed based on local data, so that training result information can be shared with the server while customer data privacy is protected. The server obtains aggregated gradient information of synthetic gradient information provided by a plurality of client devices, determines an updated model parameter, notifies each client device of the updated model parameter, and indicates each client device to continue training of an intelligent model. After completing the model training, the client device uses the trained model to provide a personalized service for the customer.

In another implementation, the solutions may be applied to an industrial wireless sensor network, to implement industrial intelligence. The central node may be a server, and the participating node may be a plurality of sensors (such as a mobile intelligent robot) in a factory. After model training is performed based on local data, the sensor sends synthetic gradient information to the server, and the server obtains aggregated gradient information based on the synthetic gradient information provided by the sensor, determines an updated model parameter, notifies each sensor of the updated model parameter, and continues training of an intelligent model. After completing the model training, the sensor uses a trained model to perform a factory task. For example, the sensor is a mobile intelligent robot that can obtain a movement route based on the trained model to complete a factory transportation task and an express sorting task.

To better understand the embodiments, several terms are briefly described below.

### 1. Artificial Intelligence (AI)

AI enables machines to learn and accumulate experience, to resolve a problem that humans can solve through experience, for example, natural language understanding, image recognition, and/or chess playing.

2. Neural network (NN): As an important branch of artificial intelligence, the neural network is a network structure that simulates behavior features of an animal neural network for information processing. A structure of the neural network is formed by a large quantity of nodes (or referred to as neurons) connected to each other. The neural network is based on an operation model, and processes information by learning and training input information. One neural network includes an input layer, a hidden layer, and an output layer. The input layer is responsible for receiving an input signal, the output layer is responsible for outputting a calculation result of the neural network, and the hidden layer is responsible for a complex function such as feature expression. The function of the hidden layer is represented by a weight matrix and a corresponding activation function.

The deep neural network (DNN) may be a multi-layer structure. Increasing the depth and the width of the neural network can improve the ability of expression of the neural network and provide more powerful information extraction and abstract modeling capabilities for complex systems. The depth of the neural network may be represented as the quantity of layers of the neural network. For one layer, the width of the neural network may be represented as the quantity of neurons included in the layer.

There may be a plurality of construction manners of the DNN, for example, including but not limited to, a recurrent neural network or a recursive neural network (RNN), a convolutional neural network (CNN), a fully connected neural network (also named as “a full-mesh neural network”), and the like.

### 3. Training or Learning

Training is a process of processing a model (or referred to as training model). In this processing process, parameters in the model, such as weighted values, are optimized, so that the model learns to perform a task. The embodiments may be applicable to, but are not limited to, one or more of the following training methods: supervised learning, unsupervised learning, reinforcement learning, transfer learning, and the like. The supervised learning refers to that the model is training performed by using a set of training samples that have been correctly labeled. Correct labeling means that each sample has an expected output value. Unlike the supervised learning, the unsupervised learning is a method that automatically classifies or groups input data with no pre-marked training sample given.

### 4. Inference

Inference means processing data by using a trained model (where the trained model may be referred to as an inference model). A corresponding inference result is obtained by inputting actual data into the inference model for processing. The inference may also be referred to as prediction or decision, and the inference result may also be referred to as a prediction result, a decision result, or the like.

### 5. Federated Learning

Federated learning is a distributed AI training method that a training process of an AI algorithm is performed on a plurality of devices instead of being aggregated to one server, so that time consumption and a large quantity of communication cost caused by data collection during centralized AI training can be alleviated. In addition, because device data does not need to be sent to the server, privacy security problems can also be improved. A process is as follows: A central node sends an AI model to a plurality of participating nodes, and the participating nodes perform AI model training based on data of the participating nodes and report the AI models trained by the participating nodes to the central node in a gradient manner. The central node performs averaging or another operation on gradient information fed back by the plurality of participating nodes, to obtain a new parameter of the AI model. The central node may send the updated parameter of the AI model to the plurality of participating nodes, and the participating nodes train the AI model again. In different federated learning processes, participating nodes selected by the central node may be the same or may be different. This is not limited.

However, in the federated learning, the gradient information received by the central node may be distorted due to impact of a transmission channel condition. In this case, efficiency of performing model training through the federated learning is low currently. The embodiments propose that the participating node may resend, to the central node, a part of the gradient information that is distorted and lost, so that the central node can obtain distortion compensation. After one time of model training, the participating node may send, to the central node, gradient information obtained through training and residual gradient information that is estimated by the participating node and that is not transmitted to the central node before the current model training. In this way, the central node can obtain the residual gradient information (or referred to as compensated gradient information), so that a convergence speed of a loss function can be improved, and the model training efficiency can be improved.

The following describes an intelligent model training method with reference to the accompanying drawings.

### Embodiment 1

FIG. 2 is a schematic flowchart of an intelligent model training method.

S201. A participating node performs a K^{th} time of model training on an intelligent model, to obtain first gradient information.

Optionally, before the participating node performs the K^{th} time of model training on the intelligent model, the participating node may receive model parameter information 1 from a central node, and the intelligent model trained in the K^{th} time of model training is a model configured based on the model parameter information 1.

For example, before the participating node receives the model parameter information 1, the intelligent model may be denoted as an intelligent model 1. After receiving the model parameter information 1, the participating node configures a parameter of the intelligent model 1 based on the model parameter information 1, to obtain an intelligent model 2. The participating node performs the K^{th} time of model training on the intelligent model 2.

The participating node trains the intelligent model by using data sample used for training and obtains the first gradient information through calculation.

For example, the participating node may obtain, from a local dataset D, a randomly selected data sample ξ^{K} (D) for the K^{th} time of model training. The participating node trains the intelligent model by using the data sample and obtains the first gradient information ∇L^{K} (Θ^{K}, ξ^{K} (D)) through calculation. Θ^{K} is a model weight indicated by the model parameter information 1. Optionally, the local dataset D may be a sample dataset obtained by the participating node through collecting sample data. The first gradient information may be abbreviated as ∇L^{K}.

For example, in a smart home scenario, the sample data may be customer preference data. The client device trains the intelligent model based on the customer preference data, and the trained intelligent model can provide a personalized service for a customer based on a customer requirement.

For another example, in an industrial wireless sensor network, the sample data may be movable route data that corresponds to a factory task and that is collected by a sensor. The sensor trains the intelligent model based on the movable route data, and the trained intelligent model can provide an optimal route based on a factory task requirement, so that the sensor (for example, a smart robot) can complete the factory task based on the optimal route.

It should be noted that the foregoing describes the foregoing two scenarios only as examples, but is not limited thereto. The method provided may be further applied to another scenario.

S202. The participating node sends first synthetic gradient information to the central node. The first synthetic gradient information includes synthetic information of the first gradient information and residual gradient information. The residual gradient information represents a residual estimate of synthetic gradient information that is not transmitted to the central node before the K^{th} time of model training.

K is a positive integer. Correspondingly, the central node receives the first synthetic gradient information from the participating node.

Optionally, the residual gradient information includes a residual estimate of second synthetic gradient information weighted by a weighting coefficient. The second synthetic gradient information is synthetic gradient information sent by the participating node to the central node after the participating node performs a Q^{th} time of model training on the intelligent model. Q is a positive integer less than K. The participating node may obtain synthetic gradient information [symbol] after an n^{th} time of intelligent model training. N is a positive integer, and [symbol] may be denoted as:

[symbol]

=∇Lⁿ+aⁿ·rⁿ (1)

∇Lⁿ is gradient information obtained through the n^{th} time of model training, aⁿ·rⁿ is the residual gradient information, and aⁿ is the weighting coefficient.

Optionally, the weighting coefficient aⁿ may be 1, or the weighting coefficient aⁿ may be related to a learning rate of the n^{th} time of model training.

The following describes the residual gradient information by using the first synthetic gradient information [symbol] obtained after the K^{th} time of intelligent model training, that is, n=K, as an example.

[symbol]

=∇L^{K}+a^{K}·r^{K}

a^{K}·r^{K} is the residual gradient information, that is, the residual gradient information included in the first synthetic gradient information obtained after the K^{th} time of model training. The residual gradient information includes the residual estimate of the synthetic gradient information that is not transmitted to the central node before the K^{th} time of model training and r^{K} may include the residual estimate of the second synthetic gradient information [symbol] . In the residual gradient information a^{K}·r^{K}, the residual estimate of the second synthetic gradient information is weighted by the weighting coefficient a^{K}.

The following describes a method for obtaining a residual estimate of synthetic gradient information by the participating node.

A transmission power gain for sending the synthetic gradient information [symbol] (in other words, the synthetic gradient information obtained after the n^{th} time of intelligent model training) by the participating node may be denoted as pⁿ. Channel information between the participating node and the central node may be denoted as hⁿ. For example, the channel information may be channel fading. The channel fading may be obtained by the participating node through performing channel estimation based on a reference signal or may be fed back by the central node. This is not limited. An equivalent transmission part of the synthetic gradient information [symbol] may be represented as \sqrt{pⁿ}|hⁿ| [symbol] , so that a residual estimate δⁿ of the synthetic gradient information [symbol] may be obtained based on the following formula:

δⁿ=(1−\sqrt{pⁿ}|hⁿ|) [symbol] (2)

The participating node may estimate, based on formula (2), the residual estimate δ^{Q} of the second synthetic gradient information [symbol] obtained after the Q^{th} time of intelligent model training as:

δ^{Q}=(1−\sqrt{p^{Q}}|h^{Q}|)

[symbol]

In this embodiment, r^{K} may include, but is not limited to, the following first implementation and second implementation.

In the first implementation, r^{K} is the residual estimate δ^{Q} of the second synthetic gradient information, that is, r^{K}=δ^{Q}.

In other words, r^{K} includes a residual estimate of one piece of synthetic gradient information that is last sent to the central node before the participating node performs the K^{th} time of intelligent model training. In this embodiment, before the K^{th} time of intelligent model training, the synthetic gradient information last sent to the central node is the synthetic gradient information obtained after the Q^{th} time of intelligent model training, that is, the second synthetic gradient information. Therefore, r^{K}=δ^{Q}.

Optionally, in the first implementation, the weighting coefficient a^{K} may be 1, or the weighting coefficient a^{K} may be related to a learning rate of the K^{th} time of model training or a learning rate of the Q^{th} time of model training.

For example, the weighting coefficient a^{K} may be a ratio

$${a}^{K} = \frac{{η}^{Q}}{{η}^{K}}$$

of the learning rate η^{K} of the K^{th} time of model training to the learning rate n^{Q} of the Q^{th} time of model training. However, is the embodiments are not limited thereto.

In an example, the Q^{th} time of model training is the previous time of model training of the K^{th} time of model training, that is, Q=K−1. In other words, synthetic gradient information sent by the participating node to the central node after one time of model training includes residual gradient information of synthetic gradient information that is sent to the central node after the previous time of model training.

In another example, N times of model training are further included between the Q^{th} time of model training and the K^{th} time of model training, that is, Q=K−N−1. The participating node does not send, to the central node, gradient information obtained after the N times of model training. In other words, synthetic gradient information sent by the participating node to the central node after one time of model training includes residual gradient information of synthetic gradient information that is sent to the central node after the previous time of model training.

Optionally, in the first implementation, if the second synthetic gradient information is synthetic gradient information sent by the participating node to the central node for the first time (for example, the Q^{th} time of training is the first time of model training, or gradient information obtained in Q−1 times of model training is not sent to the central node), because there is no synthetic gradient information (in other words, synthetic gradient information that has been sent) sent to the central node last time, there is no residual estimate, and the second synthetic gradient information [symbol] includes only the gradient information ∇L^{Q} obtained through the Q^{th} time of model training.

Optionally, in the first implementation, if the second synthetic gradient information is not synthetic gradient information sent by the participating node to the central node for the first time (in other words, the participating node has sent the synthetic gradient information to the central node before the Q^{th} time of model training), the second synthetic gradient information [symbol] includes the gradient information ∇L^{Q} obtained through the Q^{th} time of model training and the residual gradient information of the synthetic gradient information that has been sent to the central node last time before the Q^{th} time of model training.

According to the first implementation, the participating node synthesizes the residual gradient information of the first gradient information and the second synthetic gradient information and sends the residual gradient information to the central node. In this way, the central node may obtain a residual estimate of synthetic gradient information that is received from the participating node last time, so that data distortion in a transmission process can be compensated, and a convergence speed of a loss function is improved, thereby improving model training performance.

In a second implementation, r^{K} includes the residual estimate δ^{Q} of the second synthetic gradient information and synthetic information of N pieces of gradient information. The N pieces of gradient information are N pieces of gradient information that are obtained after N times of model training between the K^{th} time of model training and the Q^{th} time of model training and that are not sent by the participating node to the central node. N=K−Q−1.

In other words, r^{K} includes a residual estimate of synthetic gradient information obtained in previous time of intelligent model training (that is, a (K−1)^{th} intelligent model training) of the K^{th} time of intelligent model training, that is, r^{K}=δ^{K-1}.

r^{K}=(1−\sqrt{p^{K-1}}|h^{K-1}|)

[symbol]

In this implementation, because the synthetic gradient information is not sent to the central node after the N times of model training between the Q^{th} time of model training and the K^{th} time of model training, a transmission power gain corresponding to the N times of model training is pⁱ=0. i=K−1, . . . , K−N. Because p^{K-1}=0, r^{K}= [symbol] , that is:

r^{K}=∇L^{K-1}+a^{K-1}·r^{K-1}

The following can be obtained through further derivation:

$${r}^{K} = ∇ {L}^{K - 1} + {a}^{K - 1} \cdot ∇ {L}^{K - 2} + {a}^{K - 1} \cdot {a}^{K - 2} \cdot {r}^{K - 2} \qquad ( 3 )$$

$$= ∇ {L}^{K - 1} + {a}^{K - 1} \cdot ∇ {L}^{K - 2} + … + {\prod }_{i = K - N}^{K - 1} {a}^{i} \cdot {r}^{K - N}$$

$$= ∇ {L}^{K - 1} + {\sum }_{n = K - N}^{K - 2} {\prod }_{j = n + 1}^{K - 1} {a}^{j} ∇ {L}^{n} + {\prod }_{i = K - N}^{K - 1} {a}^{j} {r}^{K - N}$$

$${r}^{K - N} = {δ}^{K - N - 1} = {δ}^{Q} and {r}^{K} may be denoted as :$$

$${r}^{K} = ∇ {L}^{K - 1} + {\sum }_{n = K - N}^{K - 2} {\prod }_{j = n + 1}^{K - 1} {a}^{j} ∇ {L}^{n} + {\prod }_{i = K - N}^{K - 1} {a}^{i} {δ}^{Q}$$

Therefore, based on formula (3), r^{K} includes the residual estimate δ^{Q} of the second synthetic gradient information and the synthetic information of the N pieces of gradient information.

In an example, a weighting coefficient aⁿ corresponding to each intelligent model training may be 1, and n is a positive integer. When aⁿ=1, r^{K} may be the following formula, r^{K} may include a sum of the gradient information that is obtained through the N times of model training after the Q^{th} time of model training and before the K^{th} time of model training and the residual estimate of the second synthetic gradient information that is obtained after the Q^{th} time of model training.

r^{K}Σ_{n=K}^{K-1}∇Lⁿ+δ^{Q} (4)

In another example, the weighting coefficient aⁿ may be related to a learning rate of an n^{th} time of model training and/or a learning rate of an (n−1)^{th} time of model training

For example, the weighting coefficient a^{K} may be a ratio

$${a}^{K} = \frac{{η}^{K - 1}}{{η}^{K}}$$

of a learning rate η^{K} of the K^{th} time of model training to a learning rate η^{K-1} of a (K−1)^{th} time of model training. However, the embodiments are not limited thereto.

Optionally, in the second implementation, if the second synthetic gradient information is synthetic gradient information sent to the central node for the first time.

In a case, if the Q^{th} time of model training is the first time of model training, in other words, Q=1, the second synthetic gradient information [symbol] includes only gradient information ∇L^{Q} obtained through the first time of model training.

In another case, the Q^{th} time of model training is not the first time of model training, and synthetic gradient information obtained after Q−1 times of model training before the Q^{th} time of model training is not sent to the central node, that is, Q>1. In this case, the second synthetic gradient information includes gradient information ∇L^{Q} obtained after the Q^{th} time of model training and synthetic information of Q−1 pieces of gradient information obtained after the first Q−1 times of model training. Because none of the synthetic gradient information obtained after the first Q−1 times of model training is sent to the central node, pⁱ=0, i=1, . . . , Q−1. In this case, the second synthetic gradient information may be represented as:

[symbol]

=∇L^{Q}+a^{Q}·r^{Q}, where r^{Q}=∇L^{Q-1}+Σₙ₌₁^{Q-2}Πⱼ₌ₙ₊₁^{Q-1}a^{j}∇Lⁿ.

Optionally, in the second implementation, if the second synthetic gradient information is not the synthetic gradient information sent to the central node for the first time, in other words, the participating node has sent the synthetic gradient information to the central node before the Q^{th} time of model training, the second synthetic gradient information [symbol] includes the gradient information ∇L^{Q} obtained through the Q^{th} time of model training and residual gradient information before the Q^{th} time of model training. For example, synthetic gradient information sent to the central node last time before the Q^{th} time of model training is third synthetic gradient information. The third synthetic gradient information is obtained after an M^{th} time of model training, and the residual gradient information before the Q^{th} time of model training includes a residual estimate of the third synthetic gradient information weighted by a weighting coefficient and synthetic information of Q−M−1 pieces of gradient information obtained after Q−M−1 times of model training after the M th time of model training and before the Q^{th} time of model training In this optional implementation, the second synthetic gradient information may be represented as:

[symbol]

=∇L^{Q}+a^{Q}·r^{Q}, where r^{Q}=∇L^{Q-1}+Σ_{n=M+1}^{Q-2}Πⱼ₌ₙ₊₁^{Q-1}a^{j}∇Lⁿ+Π_{i=M+1}^{Q-1}a¹δ^{M}.

Optionally, the central node or a plurality of participating nodes that perform federated learning may determine, based on a policy, whether to send the gradient information to the central node after one time of model training.

In an implementation, the central node determines at least one participating node based on the policy. The at least one participating node sends the gradient information to the central node after model training and notifies the plurality of participating nodes whether to send the gradient information. After receiving a notification from the central node, the plurality of participating nodes determine whether to send the gradient information to the central node.

For example, the policy of the central node may be determining, based on a metric, for example, a data importance degree and/or a channel condition between the central node and the participating node, a participating node that is scheduled to send the gradient information. The central node notifies whether the plurality of participating nodes are scheduled, and the scheduled participating node in the plurality of participating nodes sends the synthetic gradient information to the central node after the next time of model training. An unscheduled participating node does not send the synthetic gradient information to the central node after the next time of model training, and stores the gradient information obtained after the model training.

In another implementation, the participating node determines, based on the policy, whether to send the gradient information to the central node after the model training.

For example, the participating node may determine, based on a transmission power of the synthetic gradient information, whether to send the synthetic gradient information to the central node. For example, when the transmission power is greater than a power threshold, the participating node may send the synthetic gradient information to the central node; or when the transmission power is less than or equal to a power threshold, the participating node may not send the synthetic gradient information to the central node. The participating node may determine, based on autonomous determining, whether to send the synthetic gradient information to the central node. Data distortion problems can be reduced. In this example, before the participating node sends the first synthetic gradient information to the central node, the participating node determines that a transmission power of the first synthetic gradient information is greater than the power threshold.

According to the solution in the second implementation, before the participating node performs the K^{th} time of model training, the N pieces of gradient information obtained by the participating node through the N times of model training are not sent to the central node. The participating node synthesizes the first gradient information, the residual gradient information of the second synthetic gradient information, and the N pieces of gradient information that are not sent to the central node and sends synthesized information to the central node. In this way, the central node can obtain not only gradient information that is not fed back, but also a residual amount of synthetic gradient information at a previous time. This can improve the convergence speed of a loss function and improve the model training performance.

### Embodiment 2

Embodiment 2 provides a method for determining, by a participating node based on a policy, whether to send gradient information to a central node after model training. It should be noted that, for a part in Embodiment 2 that is the same as that in Embodiment 1, refer to the description in Embodiment 1. For brevity, details are not described herein again.

After a K^{th} time of model training, the participating node calculates a transmission power of first synthetic gradient information. If the transmission power is greater than a power threshold, the participating node sends the first synthetic gradient information to a central node; or if the transmission power is less than or equal to a power threshold, the participating node does not send the first synthetic gradient information to a central node.

Optionally, the power threshold is in direct proportion to an activation power of the participating node. The activation power of the participating node is another power consumed by the participating node in one transmission other than a power consumed for transmitting a signal (or information), for example, a power consumed in a process of activating the participating node to prepare to transmit a signal.

For example, if the power threshold is a product of a communication price metric γ and the activation power Pₒₙ of the participating node, the power threshold may be denoted as γ·Pₒₙ. The communication price metric represents a cost volume of communication between the participating node and the central node. A larger γ indicates a higher requirement on a transmission power of synthetic gradient information, so that a probability that participating nodes in a poor channel condition do not send the synthetic gradient information to the central node is higher, and the participating nodes in the poor channel condition can be reduced to send the synthetic gradient information based on the communication price metric when communication cost is large. This can reduce resource waste and improve resource utilization.

Optionally, the central node sends the communication price metric to the participating node, and correspondingly, the participating node receives the communication price metric from the central node.

For example, the central node may calculate the communication price metric based on one or more of the following: a current load status of a network, a current loss value of joint training, statistics information of gradient information from a plurality of participating nodes, and prior distribution information of a dataset, and notify each participating node of the communication price metric.

Optionally, determining, by the participating node by comparing the transmission power with the transmission power threshold, whether to send the synthetic gradient information to the central node may be represented by the following formula. The participating node determines, by comparing the transmission power with the transmission power threshold, whether the transmission power is 0.

$${p}^{K} = {( \frac{1}{\frac{γ}{\vert {h}^{K} \vert} + \vert {h}^{K} \vert} )}^{2} ( {‖ ‖}_{2}^{2} ( \frac{{\vert {h}^{K} \vert}^{2}}{γ + {\vert {h}^{K} \vert}^{2}} ) > γ {P}_{o n} ) \qquad ( 5 )$$

|x| represents an amplitude of a complex number x, ∥x∥₂ represents an l₂-norm (l₂-norm) of x, and [symbol] (A) is an indication function of an event A. If A is true, [symbol] (A) is 1; otherwise, [symbol] (A) is 0.

In other words, when

$${‖ ‖}_{2}^{2} ( \frac{{\vert {h}^{K} \vert}^{2}}{γ + {\vert {h}^{K} \vert}^{2}} ) > γ {P}_{o n} ,$$

the participating node sends the first synthetic gradient information to the central node, and a transmission power gain is

$${p}^{K} = {( \frac{1}{\frac{γ}{\vert {h}^{K} \vert} + \vert {h}^{K} \vert} )}^{2} .$$

Alternatively, when

$${‖ ‖}_{2}^{2} ( \frac{{\vert {h}^{K} \vert}^{2}}{γ + {\vert {h}^{K} \vert}^{2}} ) \leq γ {P}_{o n} ,$$

the transmission power p^{K}=0, and the participating node does not send the first synthetic gradient information to the central node.

Optionally, Embodiment 2 may be implemented in combination with Embodiment 1.

For example, when Embodiment 2 is applied to the second implementation of Embodiment 1, r^{K} may be denoted as:

r^{K}(1−\sqrt{p^{K-1}}|h^{K-1}|) [symbol] (6)

When the weighting coefficient in formula (1) is 1, because the synthetic gradient information obtained after the N times of model training between the Q^{th} time of model training and the K^{th} time of model training is not sent to the central node, in other words, after the N times of model training, the transmission power gain obtained by the participating node through calculation based on formula (5) is 0. p^{K-1}=0 is substituted into formula (6). In this case, r^{K}= [symbol] and [symbol] =∇L^{K-1}+r^{K-1} may be obtained based on formula (1). The following formula may be obtained:

r^{K}=∇L^{K-1}+r^{K-1}

Then, the following formula can be obtained through further derivation:

$$\begin{matrix}{r}^{K} = {\sum }_{n = K - N}^{K - 1} ∇ {L}^{n} + {r}^{K - N} \\ {r}^{K - N} = {δ}^{K - N - 1} = {δ}^{Q} \cdot {r}^{K}\end{matrix}$$

obtained based on this formula is the same as that obtained based on formula (4) when the weighting coefficient is 1.

It should be noted that, in Embodiment 2, the weighting coefficient in formula (1) may not be 1. For example, the weighting coefficient a^{K} may be the ratio

$${a}^{K} = \frac{{η}^{K - 1}}{{η}^{K}}$$

of the learning rate η^{K} of the K^{th} time of model training to the learning rate η^{K-1} of the (K−1)^{th} time of model training. However, the embodiments are not limited thereto.

According to the solution provided in Embodiment 2, the participating node does not send the synthetic gradient information to the central node based on the communication price metric when the communication cost is large and a channel condition is poor. This can reduce resource waste and improve resource utilization. In addition, the participating node sends the synthetic gradient information to the central node, so that the central node can obtain gradient information that is not fed back (for example, residual gradient information and/or gradient information that is not sent in previous training). This can improve a convergence speed of a loss function and improve model training performance.

### Embodiment 3

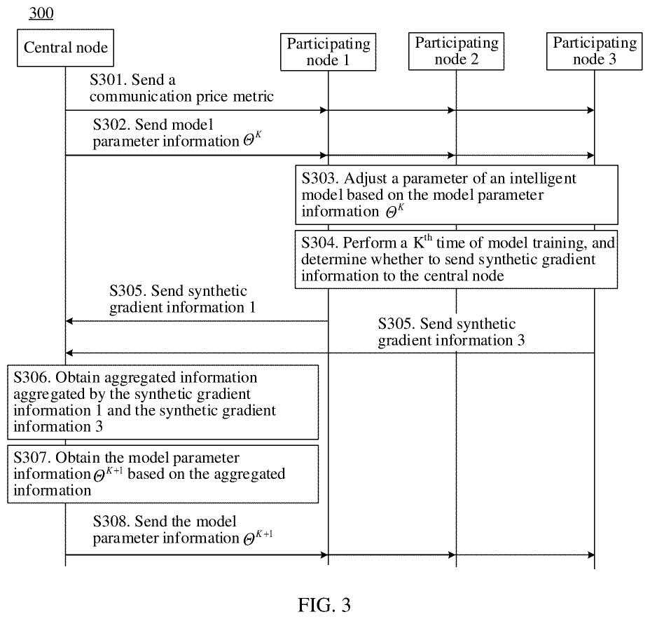

FIG. 3 is another schematic flowchart of an intelligent model training method. As shown in FIG. 3, participating nodes 1, 2, and 3 and a central node perform federated learning. The participating nodes 1, 2, and 3 perform intelligent model training, and the central node determines a model weight of each time of intelligent model training. It should be noted that FIG. 3 is described by using an example in which three participating nodes participate in federated learning. However, the quantity of participating nodes is not limited, and at least one participating node and the central node may perform the federated learning. For example, the intelligent model training method shown in FIG. 3 may be applied to the system shown in FIG. 1.

S301. The central node sends a communication price metric γ to the participating nodes that participate in joint training.

Correspondingly, the participating nodes 1, 2, and 3 receive the communication price metric γ from the central node.

For example, the central node may calculate the communication price metric based on one or more of the following: a current load status of a network, a current loss value of joint training, statistics information of gradient information from a plurality of participating nodes, and prior distribution information of a dataset, and notify each participating node of the communication price metric.

S302. The central node sends model parameter information Θ^{K} to the participating nodes that participate in the joint training.

The model parameter information K is used by the participating nodes to adjust a parameter of an intelligent model. For example, the model parameter information K includes a weight of the intelligent model.

Correspondingly, the participating nodes 1, 2, and 3 receive the model parameter information Θ^{K} from the central node.

It should be noted that a sequence of performing S301 and S302 by the central node is not limited. The communication price metric γ and the model parameter information K may be carried in a same message (in other words, S301 and S302 may be a same step), or may be carried in different messages and sent separately.

For example, the communication price metric may be periodically sent by the central node to the participating nodes. The participating node determines a transmission power gain and the like by using a communication price metric updated in a latest period.

S303. The participating nodes 1, 2, and 3 adjust the parameter of the intelligent model based on the model parameter information Θ^{K}.

S304. The participating nodes that participate in the joint training performs a K^{th} time of model training and determines whether to send synthetic gradient information to the central node.

After the participating nodes 1, 2, and 3 perform the K^{th} time of model training, the synthetic gradient information is obtained. The participating nodes 1, 2, and 3 may obtain the synthetic gradient information based on the method provided in Embodiment 1 or Embodiment 2. However, the embodiments are not limited thereto.

For example, the synthetic gradient information obtained by the participating nodes 1, 2, and 3 is synthetic gradient information 1, synthetic gradient information 2, and synthetic gradient information 3 respectively. The participating nodes 1, 2, and 3 may determine whether to send the synthetic gradient information to the central node.

For example, the participating node may calculate a transmission power of the synthetic gradient information to determine whether to send the synthetic gradient information to the central node, for example, determine, based on the foregoing formula (4), whether the transmission power gain is 0, to determine whether to send the synthetic gradient information to the central node.

In this embodiment, the participating nodes 1 and 3 determine to send the central node to the synthetic gradient information, and the participating node 2 determines not to send the synthetic gradient information to the central node.

S305. The participating nodes 1 and 3 send the synthetic gradient information 1 and the synthetic gradient information 3 to the central node.

S306. The central node obtains aggregated information aggregated by the synthetic gradient information 1 and 3.

In an implementation, the participating nodes 1 and 3 separately send the synthetic gradient information to the central node. After receiving the synthetic gradient information 1 and the synthetic gradient information 3, the central node aggregates the synthetic gradient information 1 and the synthetic gradient information 3 to obtain the aggregated information.

For example, the participating nodes 1 and 3 respectively send the synthetic gradient information 1 and the synthetic gradient information 3 to the central node on different time resources and/or frequency resources.

In another implementation, the central node allocates, to the participating nodes, a transmission resource shared by the participating nodes. All the participating nodes transmit the synthetic gradient information on the transmission resource.

In this implementation, when a plurality of participating nodes send a plurality of pieces of synthetic gradient information on the transmission resource, the plurality of pieces of synthetic gradient information can be aggregated on a radio channel. The central node receives and obtains the aggregated information on the transmission resource. This manner may also be air aggregation, air superposition, or air computing. This is not limited.

Optionally, the transmission resource may include an aggregated pilot symbol (or referred to as a common pilot symbol). The central node may estimate channel information of an aggregated channel based on the aggregated pilot symbol, and then obtain aggregated information based on the channel information and a received signal received on the transmission resource. The aggregated information may be referred to as unbiased gradient estimation information.

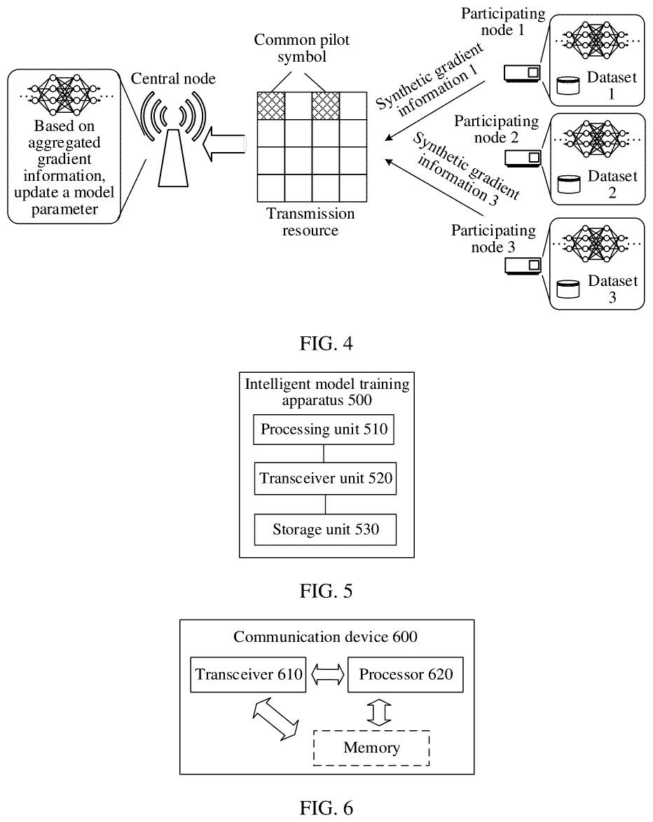

For example, as shown in FIG. 4, the central node allocates a radio resource block to the participating node as a transmission resource of synthetic gradient information, and the participating nodes 1 and 3 separately send the synthetic gradient information 1 and the synthetic gradient information 3 on the radio resource block, so that the synthetic gradient information 1 and the synthetic gradient information 3 implement air aggregation on the radio resource block, and the central node receives, on the radio resource block, the aggregated information obtained through the air aggregation. The central node estimates/counts channel information based on the shared pilot symbol included in the radio resource block, and obtains the aggregated information based on the channel information and the received signal received on the transmission resource.

S307. The central node obtains model parameter information Θ^{K+1} based on the aggregated information.

For example, the aggregated information obtained by the central node is denoted as ĝ^{K}, and the central node obtains new model parameter information Θ^{K+1}=Θ^{K}−η^{K}ĝ^{K} based on the aggregated information r and the model parameter information Θ^{K}.

S308. The central node sends the model parameter information Θ^{K+1} to the participating nodes that participate in the joint learning.

Correspondingly, the participating nodes 1, 2, and 3 receive the model parameter information Θ^{K+1} from the central node.

The central node may include an updated communication price metric and the model parameter information Θ^{K+1} in a same message, and send the message to the participating nodes 1, 2, and 3. However, the embodiments are not limited thereto. For example, the communication price metric and the model parameter information may not be carried in a same message, or the central node periodically sends the communication price metric at a period.

According to the solution in Embodiment 3, the central node may send the communication price metric to the participating node, so that participating nodes in a poor channel condition can be reduced to send synthetic gradient information based on the communication price metric when communication cost is large. This reduces resource waste and improves resource utilization. In addition, the participating node sends the synthetic gradient information to the central node, so that the central node can obtain gradient information that is not fed back (for example, residual gradient information and/or gradient information that is not sent in previous training). This can improve a convergence speed of a loss function and improve model training performance.

The methods provided in the embodiments are described above in detail with reference to FIG. 2 and FIG. 3. The following describes in detail apparatuses provided in the embodiments. To implement functions in the methods provided in the foregoing embodiments, each network element may include a hardware structure and/or a software module and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular embodiments and constraints of the solutions.

FIG. 5 is a schematic block diagram of an intelligent model training apparatus according to an embodiment. As shown in FIG. 5, the intelligent model training apparatus 500 may include a processing unit 510 and a transceiver unit 520.

The intelligent model training apparatus 500 may correspond to the participating node in the foregoing method embodiments, or a chip configured in (or used in) the participating node, or may be another apparatus, module, circuit, unit, or the like that can implement a method performed by the participating node.

It should be understood that the intelligent model training apparatus 500 may correspond to the participating node in the method 200 and the method 300 in the embodiments. The intelligent model training apparatus 500 may include a unit configured to perform the methods performed by the first device in the method 200 and the method 300 in FIG. 2 and FIG. 3. In addition, each unit in the intelligent model training apparatus 500 and the foregoing other operations and/or functions are respectively used to implement corresponding procedures of the methods 200 and 300 in FIG. 2 and FIG. 3.

When the intelligent model training apparatus 500 is configured to implement the corresponding procedure performed by the participating node in the foregoing method embodiments, the processing unit 510 performs a K^{th} time of model training on an intelligent model, to obtain first gradient information. The transceiver unit 520 is configured to send first synthetic gradient information to a central node. The first synthetic gradient information includes synthetic information of the first gradient information and residual gradient information. The residual gradient information represents a residual estimate of synthetic gradient information that is not transmitted to the central node before the K^{th} time of model training, where K is a positive integer.

It should be further understood that when the intelligent model training apparatus 500 is the chip configured in (or used in) the participating node, the transceiver unit 520 in the intelligent model training apparatus 500 may be an input/output interface or a circuit of the chip, and the processing unit 510 in the intelligent model training apparatus 500 may be a logic circuit in the chip.

In another possible embodiment, the intelligent model training apparatus 500 may correspond to the central node in the foregoing method embodiments, for example, a chip configured in (or used in) the central node, or another apparatus, module, circuit, or unit that can implement a method performed by the central node.

It should be understood that the intelligent model training apparatus 500 may correspond to the central node in the method 200 and the method 300 in the embodiments. The intelligent model training apparatus 500 may include a unit configured to perform the methods performed by the central node in the method 200 and the method 300 in FIG. 2 and FIG. 3. In addition, each unit in the intelligent model training apparatus 500 and the foregoing other operations and/or functions are respectively used to implement corresponding procedures of the methods 200 and 300 in FIG. 2 and FIG. 3.

It should be further understood that when the intelligent model training apparatus 500 is the chip configured in (or used in) the central node, the transceiver unit 520 in the intelligent model training apparatus 500 may be an input/output interface or a circuit of the chip, and the processing unit 510 in the intelligent model training apparatus 500 may be a logic circuit in the chip. Optionally, the intelligent model training apparatus 500 may further include a storage unit 530. The storage unit 530 may be configured to store instructions or data. The processing unit 510 may execute the instructions or the data stored in the storage unit, to enable the intelligent model training apparatus to implement a corresponding operation.

It should be understood that the transceiver unit 520 in the intelligent model training apparatus 500 may be implemented by using a communication interface (for example, a transceiver or an input/output interface), for example, may correspond to a transceiver 610 in a communication device 600 shown in FIG. 6. The processing unit 510 in the intelligent model training apparatus 500 may be implemented by using at least one processor, for example, may correspond to a processor 620 in the communication device 600 shown in FIG. 6. The processing unit 510 in the intelligent model training apparatus 500 may be further implemented by using at least one logic circuit. The storage unit 530 in the intelligent model training apparatus 500 may correspond to a memory in the communication device 600 shown in FIG. 6.

It should be further understood that a process in which the units perform the foregoing corresponding steps is described in detail in the foregoing method embodiments. For brevity, details are not described herein.

FIG. 6 is a schematic diagram of a structure of a communication device 600 according to an embodiment.

The communication device 600 may correspond to the participating node in the foregoing method embodiments. As shown in FIG. 6, the participating node 600 includes a processor 620 and a transceiver 610. Optionally, the participating node 600 further includes a memory. The processor 620, the transceiver 610, and the memory may communicate with each other via an internal connection path, to transfer a control signal and/or a data signal. The memory is configured to store a computer program, and the processor 620 is configured to execute the computer program in the memory, to control the transceiver 610 to receive and send a signal.

It should be understood that the communication device 600 shown in FIG. 6 can implement the processes related to the participating node in the method embodiments shown in FIG. 2 and FIG. 3. An operation and/or a function of each module in the participating node 600 are/is respectively used to implement corresponding procedures in the foregoing method embodiments. For details, refer to the descriptions in the foregoing method embodiments. To avoid repetition, detailed descriptions are properly omitted herein.

The communication device 600 may correspond to the central node in the foregoing method embodiments. As shown in FIG. 6, the central node 600 includes the processor 620 and the transceiver 610. Optionally, the central node 600 further includes the memory. The processor 620, the transceiver 610, and the memory may communicate with each other via the internal connection path, to transfer the control signal and/or the data signal. The memory is configured to store the computer program, and the processor 620 is configured to execute the computer program in the memory, to control the transceiver 610 to receive and send the signal.

It should be understood that the communication device 600 shown in FIG. 6 can implement the processes related to the central node in the method embodiments shown in FIG. 2 and FIG. 3. An operation and/or a function of each module in the central node 600 are/is respectively used to implement corresponding procedures in the foregoing method embodiments. For details, refer to the descriptions in the foregoing method embodiments. To avoid repetition, detailed descriptions are properly omitted herein.

The processor 620 and the memory may be integrated into one processing apparatus. The processor 620 is configured to execute program code stored in the memory to implement the foregoing functions. During implementation, the memory may also be integrated into the processor 620 or may be independent of the processor 620. The processor 620 may correspond to the processing unit in FIG. 5.

The transceiver 610 may correspond to the transceiver unit in FIG. 5. The transceiver 610 may include a receiver (or referred to as a receiver machine or a receiver circuit) and a transmitter (or referred to as a transmitter machine or a transmitter circuit). The receiver is configured to receive a signal, and the transmitter is configured to transmit a signal.

It should be understood that the communication device 600 shown in FIG. 6 can implement the processes related to the terminal device in the method embodiments shown in FIG. 2 and FIG. 3. An operation and/or a function of each module in the communication device 600 are/is respectively intended to implement corresponding procedures in the foregoing method embodiments. For details, refer to the descriptions in the foregoing method embodiments. To avoid repetition, detailed descriptions are properly omitted herein.

This embodiment further provides a processing apparatus, including a processor and a (communication) interface. The processor is configured to perform the method according to any one of the foregoing method embodiments.

It should be understood that the processing apparatus may be one or more chips. For example, the processing apparatus may be a field programmable gate array (FPGA), an application-specific integrated chip (ASIC), a system on chip (SoC), a central processing unit (CPU), a network processor (NP), a digital signal processing circuit (e.g. a digital signal processor(DSP)), a microcontroller (MCU), a programmable controller (e.g. a programmable logic device (PLD)), or another integrated chip.

According to the methods provided in the embodiments, the embodiments further provide a computer program product. The computer program product includes computer program code. When the computer program code is executed by one or more processors, an apparatus including the processor is enabled to perform the methods in the embodiments shown in FIG. 2 and FIG. 3.

All or a part of the solutions provided in the embodiments may be implemented by using software, hardware, firmware, or any combination thereof. When the software is used to implement the embodiments, all or a part of the embodiments may be implemented in a form of a computer program product. The computer program product includes one or more computer instructions. When the computer program instructions are loaded and executed on the computer, the procedure or functions according to the embodiments are all or partially generated. The computer may be a general-purpose computer, a special-purpose computer, a computer network, a network device, a terminal device, a core network device, a machine learning device, or another programmable apparatus. The computer instructions may be stored in a non-transitory computer-readable storage medium or may be transmitted from a non-transitory computer-readable storage medium to another non-transitory computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The non-transitory computer-readable storage medium may be any usable medium accessible by the computer, or a data storage device such as a server or a data center, integrating one or more usable media. The usable medium may be a magnetic medium (for example, a floppy disk, a hard disk, or a magnetic tape), an optical medium (for example, a digital video disc (DVD)), a semiconductor medium, or the like.

According to the methods provided in the embodiments, the embodiments further provide a non-transitory computer-readable storage medium. The non-transitory computer-readable storage medium stores program code. When the program code is run by one or more processors, an apparatus including the processor is enabled to perform the methods in the embodiments shown in FIG. 2 and FIG. 3.

According to the methods provided in the embodiments, the embodiments further provides a system, including the foregoing one or more first devices. The system may further include the foregoing one or more second devices.

Optionally, the first device may be a network device or a terminal device, and the second device may be a device that communicates with the first device through a radio link

In the several embodiments, it should be understood that the system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the embodiments.

The foregoing descriptions are merely implementations of the embodiments but are not intended to limit their scope. Any variation or replacement readily figured out by a person skilled in the art within the scope of the embodiments shall fall within their scope.

1. A method, wherein a plurality of participating nodes jointly train an intelligent model, and the method is performed by one of the plurality of participating nodes, the method comprising:
performing a K^{th} time of model training on the intelligent model, to obtain first gradient information; and
sending first synthetic gradient information to a central node, wherein the first synthetic gradient information comprises synthetic information of the first gradient information and residual gradient information, and the residual gradient information represents a residual estimate of synthetic gradient information that is not transmitted to the central node before the K^{th} time of model training, wherein K is a positive integer.

2. The method according to claim 1, wherein the residual gradient information comprises a residual estimate of second synthetic gradient information weighted by a weighting coefficient, and the second synthetic gradient information comprises synthetic gradient information that is last sent to the central node before the K^{th} time of model training.

3. The method according to claim 2, wherein the residual estimate of the second synthetic gradient information is associated with the second synthetic gradient information, a transmission power corresponding to the second synthetic gradient information, and channel information corresponding to the second synthetic gradient information.

4. The method according to claim 2, wherein the second synthetic gradient information comprises synthetic gradient information that is sent to the central node after a Q^{th} time of model training, Q is a positive integer less than K, and
the weighting coefficient is associated with one or more of:
a learning rate of the K^{th} time of model training, or
a learning rate of the Q^{th} time of model training.

5. The method according to claim 2, wherein the second synthetic gradient information comprises the synthetic gradient information that is sent to the central node after the Q^{th} time of model training, the residual gradient information further comprises synthetic information of N pieces of gradient information, and the N pieces of gradient information are gradient information that is obtained through N times of model training after the Q^{th} time of model training and before the K^{th} time of model training and that is not sent to the central node before the K^{th} time of model training, wherein K is greater than Q, N=K−Q−1, and Q is a positive integer.

6. The method according to claim 1, where a transmission power corresponding to the first synthetic gradient information is greater than a power threshold and the method further comprises:
sending the first synthetic gradient information to the central node.

7. The method according to claim 6, where the transmission power of the first synthetic gradient information is associated with communication price metric information, channel information corresponding to the first synthetic gradient information, and the first synthetic gradient information, wherein the communication price metric information represents a cost volume of communication between one participating node and the central node.

8. The method according to claim 6, wherein the power threshold is in direct proportion to the communication price metric information and/or the power threshold is in direct proportion to an activation power of the participating node, and the communication price metric information represents the cost volume of communication between the participating node and the central node.

9. The method according to claim 7, further comprising:
receiving the communication price metric information from the central node.

10. The method according to claim 1, further comprising:
receiving model parameter information from the central node; and
performing the K^{th} time of model training on the intelligent model, wherein the intelligent model is a model configured based on the model parameter information.

11. An apparatus, comprising:
a processing circuit, configured to perform a K^{th} time of model training on an intelligent model, to obtain first gradient information; and
a transceiver, configured to send first synthetic gradient information to a central node, wherein the first synthetic gradient information comprises synthetic information of the first gradient information and residual gradient information, and the residual gradient information represents a residual estimate of synthetic gradient information that is not transmitted to the central node before the K^{th} time of model training, and K is a positive integer.

12. The apparatus according to claim 11, wherein the residual gradient information comprises a residual estimate of second synthetic gradient information weighted by a weighting coefficient, and the second synthetic gradient information comprises synthetic gradient information that is last sent to the central node before the K^{th} time of model training.

13. The apparatus according to claim 12, where the residual estimate of the second synthetic gradient information is associated with the second synthetic gradient information, a transmission power corresponding to the second synthetic gradient information, and channel information corresponding to the second synthetic gradient information.

14. The apparatus according to claim 12, wherein the second synthetic gradient information comprises synthetic gradient information that is sent to the central node after a Q^{th} time of model training, Q is a positive integer less than K, and
the weighting coefficient is associated with one or more of:
a learning rate of the K^{th} time of model training, or
a learning rate of the Q^{th} time of model training.

15. The apparatus according to claim 13, wherein the second synthetic gradient information comprises the synthetic gradient information that is sent to the central node after the Q^{th} time of model training, the residual gradient information further comprises synthetic information of N pieces of gradient information, and the N pieces of gradient information are gradient information that is obtained through N times of model training after the Q^{th} time of model training and before the K^{th} time of model training and that is not sent to the central node before the K^{th} time of model training, wherein K is greater than Q, N=K−Q−1, and Q is a positive integer.

16. The apparatus according to claim 11, where a transmission power corresponding to the first synthetic gradient information is greater than a power threshold; and
the transceiver is further configured to send the first synthetic gradient information to the central node when the transmission power corresponding to the first synthetic gradient information is greater than the power threshold.

17. The apparatus according to claim 16, where the transmission power of the first synthetic gradient information is associated with communication price metric information, channel information corresponding to the first synthetic gradient information, and the first synthetic gradient information, wherein the communication price metric information represents a cost volume of communication between a participating node and the central node.

18. The apparatus according to claim 16, wherein the power threshold is in direct proportion to the communication price metric information and/or the power threshold is in direct proportion to an activation power of the participating node, and the communication price metric information represents the cost volume of communication between the participating node and the central node.

19. The apparatus according to claim 17, wherein
the transceiver is further configured to receive the communication price metric information from the central node.

20. The apparatus according to claim 11, wherein
the transceiver is further configured to receive model parameter information from the central node,
the processing circuit is further configured to perform the K^{th} time of model training on the intelligent model, and the intelligent model is a model configured based on the model parameter information.
